(19) United States
(12) Patent Application Publication
(10) Pub. No.: US 2014/0339016 A1
(43) Pub. Date: Nov. 20, 2014

(54) SLOPED ROOF FALL ARREST SYSTEM AND BRACE

(71) Applicants: Raymond Hopkins, Uxbridge (CA); Peter Stapleton, Richmond Hill (CA)

(72) Inventors: Raymond Hopkins, Uxbridge (CA); Peter Stapleton, Richmond Hill (CA)

(21) Appl. No.: 14/294,342

(22) Filed: Jun. 3, 2014

Related U.S. Application Data
(63) Continuation of application No. 13/369,499, filed on Feb. 9, 2012.

(51) Int. Cl. E04G 21/32; A62B 35/00

(52) U.S. Cl. CPC E04G 21/3214; A62B 35/0068
USPC 182/3; 248/237

(57) ABSTRACT

A slip-on eave brace and a system incorporating the same for providing fall arrest on a sloped roof is disclosed. The slip-on eave brace has a soffit load distributing member, a vertical member coupled to the soffit load distributing member at one end portion thereof, and a sloped roof engaging member coupled to an opposite end portion of the vertical member. A safety line attachment member is fixed to an opposite end portion of sloped roof engaging member to the coupling with the vertical member. In a fall arrest event, fall forces are transferred via the safety line into the slip-on eave brace and into the eave of a sloped roof. A sloped roof fall arrest system can use one or more slip-on cave braces to provide fall protection to one or more workers on a sloped roof.

### CROSS REFERENCE TO RELATED APPLICATIONS

This application is a continuation application of U.S. patent application Ser. No. 13/369,499 filed Feb. 9, 2012, the contents of which are incorporated herein by reference.

### FIELD

The present disclosure relates generally to fall restraint devices and systems. More particularly, the disclosure relates to fall restraint devices and systems for use with sloped roofs.

### BACKGROUND

The need for fall restraint devices for people climbing on sloped roofs of buildings has long been recognized in order to provide roofers, building inspectors, homeowners and others a safe and secure way to work on a sloped roof. Also, government regulations typically stipulate that individuals working at height must be protected from falls. Typically, anchor devices are secured to the roof and support persons climbing on the roof by attached straps, ropes, or the like. These known roof anchors have generally involved legs that will fit over the peak of a roof and that are then secured in place with a penetrating fastener, such as nails. These roof anchors have included means for attaching a safety line that is then secured to belts or harnesses worn by persons climbing on the sloped roof.

Commonly used roof anchors require an invasive installation that damages the roof structure since the anchor fasteners must penetrate the roof in order to be attached. This can damage the water-tight integrity of the roof making this type anchor especially unsuited for a finished roof.

Installation of the roof anchors can also be dangerous for the worker to install since it typically requires a worker to carry tools and the anchors onto the roof when the worker is unprotected by a fall arrest system. Working at height to install an anchor without fall protection is also contrary to government regulation. Because of the size, weight, and bulkiness of known roof anchors it is difficult for users to carry them up ladders and pitched roofs or to re-position them on the roof. Also, the anchors are not easily moveable once installed.

U.S. Pat. No. 5,730,246 to Beard describes a fall protection apparatus that includes a mast assembly, a cable support structure and a cable. The mast assembly is disposed between the ground and soffit to provide strength and stability, and the cable support structure is attached to the mast assembly. In the loaded condition, a soffit load bearing member and a roof load bearing member carry the load of the worker. In practice, the fall protection apparatus described by Beard is heavy, difficult to install or re-position and would typically require the worker use another form of fall protection during setup. The cable support structure described by Beard distributes the load mainly to the roof surface and also the soffit.

### SUMMARY

According to a first aspect, a slip-on cave brace device is provided for fall protection on a sloped roof, the slip-on eave comprising a soffit load distributing member; a vertical member coupled to the soffit load distributing member at one end portion of the vertical member and a sloped roof engaging member coupled to a second end portion of the vertical member, the sloped roof engaging member having a safety line attachment member fixed to the an opposing end portion of the sloped roof engaging member opposite the end coupled to the vertical member. In some aspects, the sloped roof engaging member is hingedly coupled to the vertical member to allow an angle between vertical member and sloped roof engaging member to be adjusted, and the slip-on cave brace further comprising a position lock to fix the angle between vertical member and sloped roof engaging member. In yet another aspect, the position lock further comprises a compressive adjustment mechanism to apply a compressive force between sloped roof engaging member and soffit load distributing member. In still yet another aspect, the slip-on cave brace of further comprises a friction member on a lower surface of the sloped roof engaging member.

According to a second aspect, a sloped roof fall arrest system is provided for fall protection to a worker on a sloped roof having eaves using an embodiment of the slip-on eave brace described herein, the system comprising the slip-on eave brace device coupled to one of the eaves; a safety line coupled to the safety line attachment member, and the safety line provided to a sloped roof surface opposing the eave; and a rope grab to fixedly couple the user to the safety line to provide fall protection on the sloped roof surface opposing the eave. In a related aspect, a sloped roof fall arrest system is provided at least two slip-on eave brace devices for coupling to opposing eaves of the sloped roof; a safety line connected between the safety line attachment members of the at least two slip-on eave brace devices; and a coupling mechanism to couple the user to the safety line to allow the user to have fall-protected travel on the sloped roof between the at least two slip-on eave brace devices. In some aspects, the coupling mechanism can be a carabiner.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is an exploded view of an eave of a sloped roof;

FIG. 2 is a perspective view of an embodiment of a slip-on eave brace;

FIG. 3 is a perspective of the slip-on eave brace shown in FIG. 2 coupled to a sloped roof;

FIG. 4 is a perspective view of an embodiment of a slip-on eave brace that is adjustable for sloped roofs of various pitches;

FIG. 5 is a side view of the slip-on eave brace shown in FIG. 4;

FIG. 6 is a side view of a non-hinge adjustable slip-on eave brace embodiment coupled to a sloped roof;

FIG. 7 is a perspective view of a dual-arm embodiment of a frame construction embodiment of a slip-on eave brace;

FIG. 8 is a perspective view of a single-arm embodiment of a frame construction embodiment of a slip-on eave brace;

FIG. 9 is a perspective view of a dual-arm embodiment of a frame construction embodiment of a slip-on eave brace having a load bar with a shock absorber;

FIG. 10 is a perspective view of a dual-arm embodiment of a frame construction embodiment of a collapsible slip-on eave brace;

FIG. 11 is a perspective view of an embodiment of a slip-on eave brace having an adjustable height vertical member; and

FIG. 12 is a top plan view of a sloped roof fall arrest system installed on a sloped roof.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

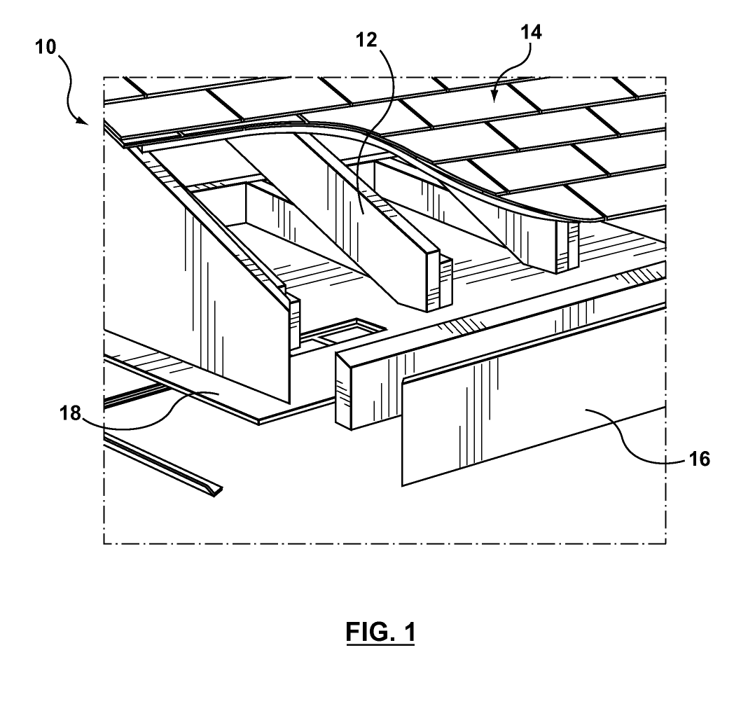

Referring to FIG. 1, an exploded view of an eave 10 of a sloped roof is shown. Eave 10 is the lower edges of the sloped roof that project beyond the walls of the building. A typical sloped roof is comprised of rafters or trusses 12 that supports roof surface 14. Fascia 16 and soffit 18 close off the area beneath the overhang of eave 10, Fascia 16 covers the ends of rafters or trusses 12 and provides a surface for attaching gutters or eaves trough (not shown). Soffit 18 can be comprised of protective paneling that spans the area between fascia 16 and the side of the building. Soffit 18 is typically constructed from weaker material (thin plywood or vinyl) as soffit 18 is non-load bearing.

Although some embodiments may explicitly refer to the sloped roof of FIG. 1, it will be understood by those of ordinary skill in the art that teachings described herein may be applied to other similar roofing structures having a sloped roof and overhanging eave.

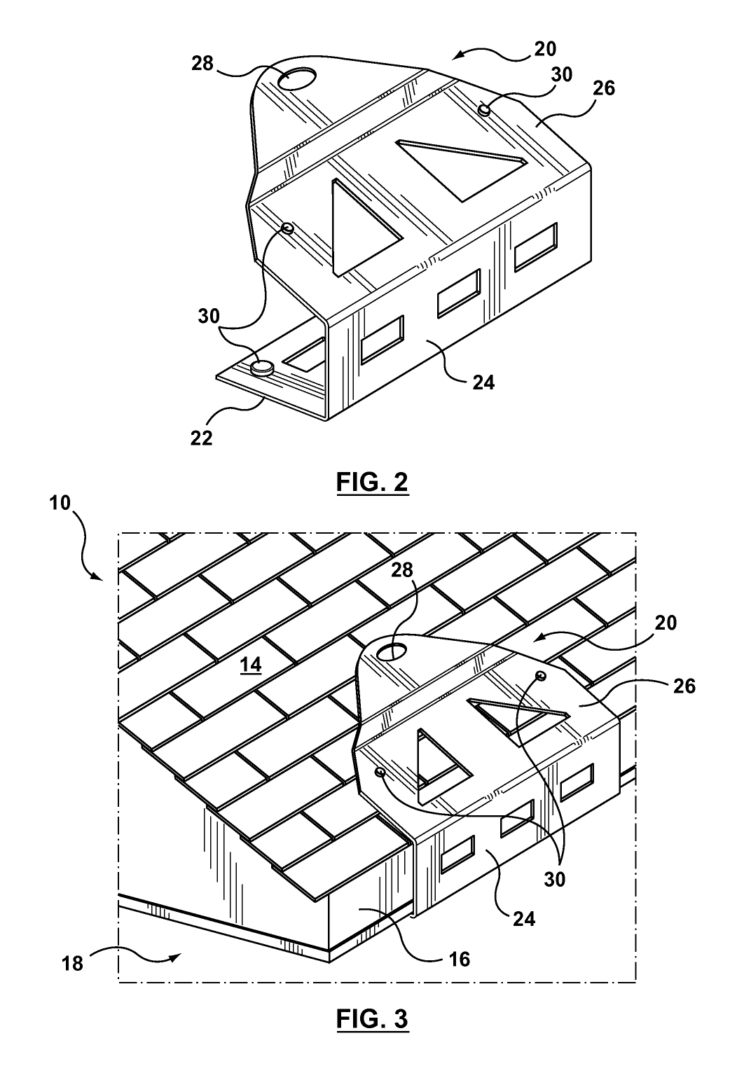

Referring now to FIG. 2, a perspective view is shown of a slip-on eave brace 20 having a soffit load distributing member 22, a vertical member 24 coupled to soffit load distributing member 22 and an end portion of sloped roof surface engaging member 26 coupled to vertical member 24. In the embodiment shown, each of the members 22, 24, 26 of slip-on eave brace 20 are formed as a single integral brace although other embodiments can have some separate members that are coupled together that can provide adjustability or other features as will be described below. Slip-on eave brace 20 is designed such that soffit load distributing member 22, vertical member 24 and sloped roof surface engaging member are adjacent, or preferably abutting, soffit 18, fascia 16 and roof surface 14, respectively. In some cases, soffit 18 can have a gutter that prevents abutment of vertical member 24 with fascia 16.

A safety line attachment member 28 that is attached to an opposing end portion of sloped roof engaging member 26 opposite the end portion coupled to vertical member 24. Safety line attachment member 28 allows a safety line to be attached to slip-on eave brace 20. Safety line attachment member 28 is on an upper portion of sloped roof surface engaging member 26 opposite the portion coupled to vertical member 24. Safety line attachment member 28 is preferably disposed along roof surface 14 so that fall arrest forces are applied through the length of sloped roof surface engaging member 26 such that the fall arrest forces are applied to fascia 16 and soffit 18 by vertical member 24 and soffit load distributing member 22 respectively.

Slip-on eave brace 20 can easily be installed on eave 10 without any damage or penetration of the roof structure contrary to the roofing anchors currently in use that rely on fasteners, such as nails or screws, that penetrate roof surface 14. Slip-on eave brace 20 is illustrated having cut-outs to reduce the weight while maintaining the desired strength and flexibility. Preferably, slip-on eave brace 20 and all load bearing elements thereof have strength to resist a force of at least 8 kilo-Newtons (1,800 lbs.), or more preferably at least 22 kilo-Newtons (5,000 lbs.).

Slip-on eave brace 20 is illustrated in FIG. 3 showing a perspective view of brace 20 coupled to eave 10 of a sloped roof. The embodiment of slip-on eave brace 20 illustrated in FIGS. 2 and 3 is designed for a specific pitch angle of a sloped roof, and brace 20 can be manufactured to accommodate many of the commonly used roof pitch angles. Slip-on eave brace 20 can include one or more friction members 30 on the surfaces that engage eave 10 of sloped roof surface engaging member 26 and/or soffit load distributing member 22 that allow brace 20 to be placed on a roof and maintain its position on the eave without the application of external forces. Preferably, one or more friction members 30 are placed on the lower surface of sloped roof engaging member 26 that engages roof surface 14. The surface area of friction members 30 spreads the weight of slip-on eave brace 20 across the roof elements to prevent overexerting on any single point of loading.

Friction members 30 can include pads that are composed of a malleable material, such as rubber for example. Other examples can include rubberized-like material, such as belting or matting for example, that is secured to the lower surface of sloped roof engaging member 26 and/or the upper surface of soffit load distributing member 22. Other embodiments can include a hard piercing or rough grip that can be preferable for roofs covered with ice or snow. Friction members 30 can also be composed of fiberglass or composite materials for longevity. In other embodiments of slip-on eave brace 20, friction member 30 can comprise a coating with a rubber-like material to provide increased friction with the roof surface. Slip-on eave brace 20 can have holes that are defined in sloped roof engaging member 26 and/or soffit load distributing member 22 into which friction members 30 can be placed to allow different friction members 30 to be inserted for different roof surfaces or to replace worn friction members 30.

Slip-on eave brace 20 is designed to transfer fall arrest forces to eave 10 of a sloped roof. A workman on a sloped roof would be attached to the safety line that is coupled to safety line attachment member 28. Slip-on eave brace 20 provides fall protection to a worker on the roof surface across the peak of the roof from brace 20. In a fall event, fall arrest forces are transferred through the safety line to slip-on eave brace 20 in a direction upwards along roof surface 14 towards the peak of the roof. Slip-on eave brace 20 would then distribute those fall arrest forces to fascia 16 and soffit 18 of eave 10 through soffit load distributing member 22 and vertical member 24.

Although installation of slip-on eave brace 20 is non-invasive, damage may still occur to soffit 18 and fascia 16 in a fall event when fall arrest forces are applied to eave 10. Gutters can also be damaged in a fall event if attached to fascia 16. Typically, these roof elements can be easily repaired on the rare occasion that slip-on eave brace 20 arrests fall forces.

Soffit load distributing member 22 can be configured to be wide enough to apply forces to at least two rafters 12 underlying soffit 18 as the material of soffit 18 is typically not strong enough itself to resist the fall arrest forces. Traditional roofing designs typically space rafters 12 about 16 to 24 inches apart which leads to a preferable width of soffit load distributing member 22 of at least 32 inches. Preferably, soffit load distributing member 22 has a large surface area to more efficiently distribute fall arrest forces and minimize any potential damage to soffit 18.

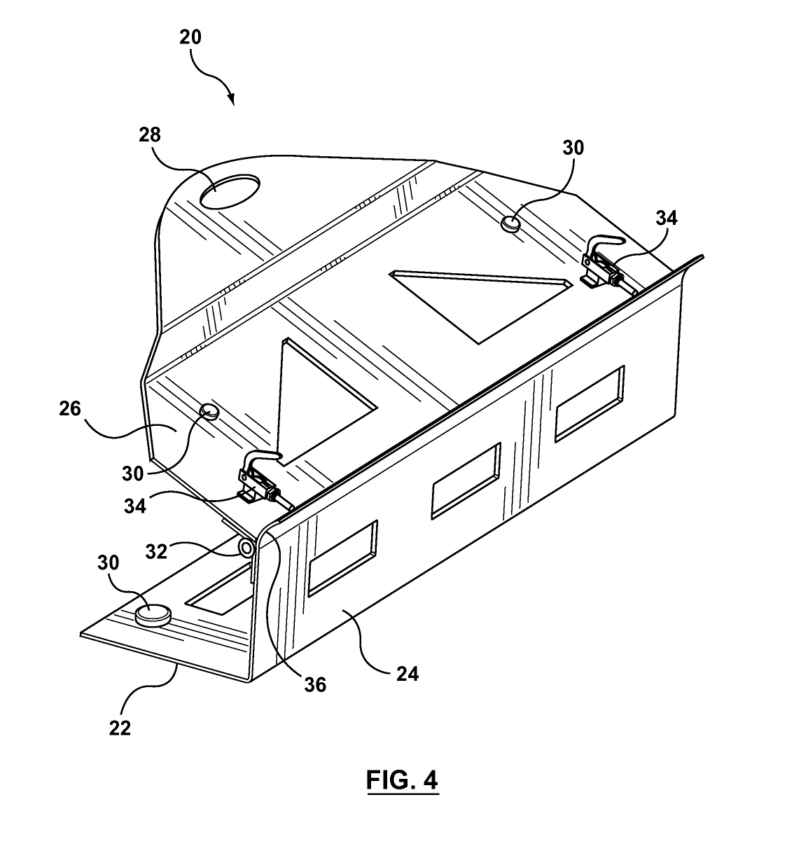

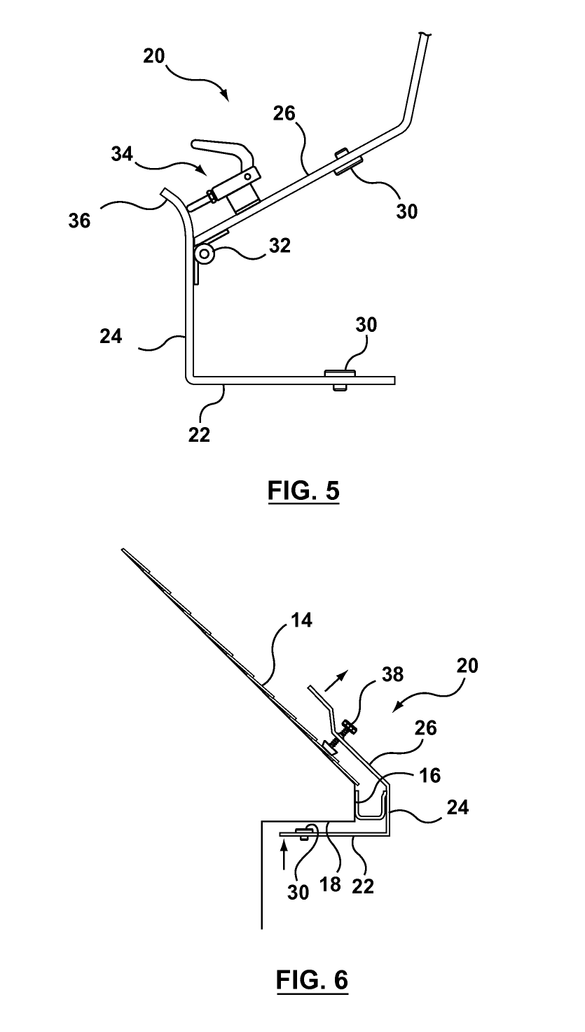

Now referring to FIGS. 4 and 5, an alternative embodiment of slip-on eave brace 20 to accommodate sloped roofs of various pitches is illustrated. Vertical member 24 is hingedly coupled to sloped roof engaging member 26 to allow the angle between vertical member 24 and sloped roof engaging member 26 to be adjusted for slope of the roof. Hinge 32 can be implemented in any number of ways as may be known to a person of skill in the art. Hinge 32 can be freely adjustable or have a number of preset positions to accommodate common roof pitches. Hinge 32 can further include a position lock that fixes the angle between vertical member 24 and sloped roof engaging member 26. The position lock can be integral with hinge 32 or a separate locking element.

In some embodiments of slip-on cave brace 20, herein referred to as clasping, the position lock can include a compressive adjustment mechanism that applies compressive forces to the cave after slip-on cave brace 20 has been placed onto cave 10 to maintain slip-on cave brace 20 in position. In other embodiments, herein referred to as non-clasping, the position lock may simply allow adjustment of the angle between vertical member 24 and sloped roof engaging member 26 to lock into a preferred angle, including a number of preset positions, that accommodates the roof slope prior to placing slip-on cave brace 20 on cave 10. An example of a position lock in a non-clasping embodiment can include a locking swivel.

FIGS. 4 and 5 illustrate an embodiment of a clasping slip-on cave brace 20 that uses a compressive adjustment mechanism to apply compressive force between soffit load distributing member 22 and sloped roof engaging member 26 in order to clasp eave 10. Vertical member 24 has an outwardly curved portion 36 that extends above hinge 32 and sloped roof engaging member 26. The profile of curved portion 36 is designed to maintain a generally perpendicular angle with a plunger of compressive adjustment mechanism throughout the hinged motion between vertical member 24 and sloped roof engaging member 26. Compressive adjustment mechanism 34 can be implemented using a straight line clamp, as illustrated in FIGS. 4 and 5, or other suitable clamps known in the art. Compressive adjustment mechanism 34 can also be integral with hinge 32 such as in a ratcheting swivel for example.

A compressive adjustment mechanism 34 can also be used with a non-hinge embodiment of slip-on eave brace 20 as illustrated in FIG. 6. Compressive adjustment mechanism comprises a screw plunger 38 that mates with a threaded bore in sloped roof engaging member 26 to allow screw plunger 38 to engage roof surface 14. As screw plunger 38 is screwed into slope roof engaging member 26 the bottom surface of soffit load distributing member 22 moves toward soffit 18 to clasp slip-on cave brace 20 to eave 10. Screw plunger 38 compressive adjustment mechanism can also be used with slip-on eave brace having a locking hinge, particularly those having preset locking positions. Preferably, more than one screw plunger 38 is used for redundancy and each has a sufficiently large surface area for frictionally engaging roof surface 14.

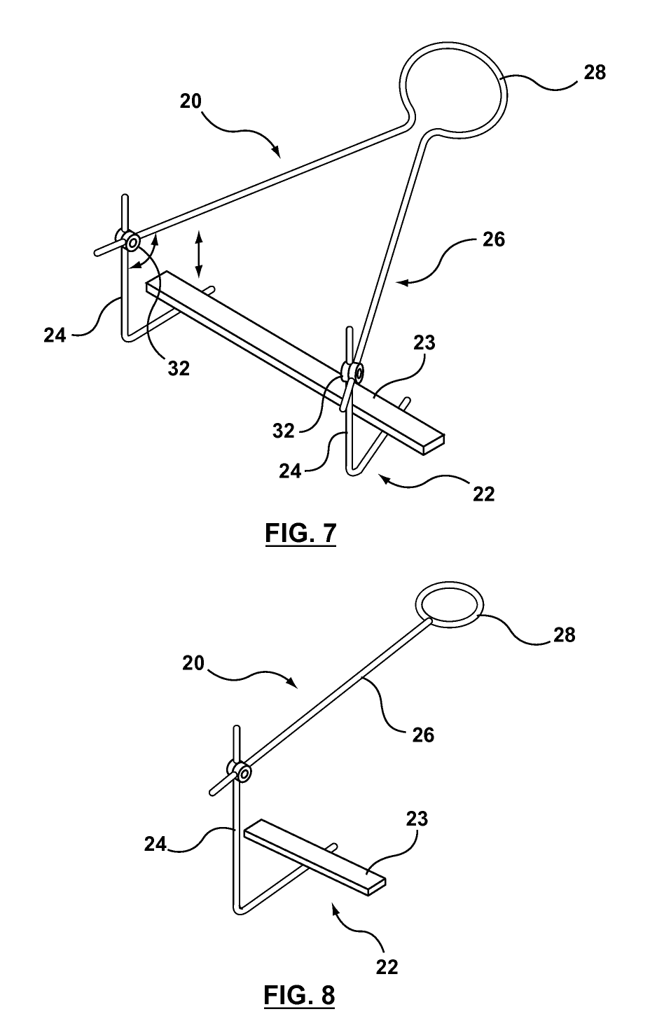

Referring to FIGS. 7 and 8, alternative embodiments of slip-on eave brace 20 using a frame construction are illustrated. Soffit load distributing member 22, vertical member 24 and a sloped roof surface engaging member 26 can each be comprised of frame elements composed of bars or tubing that can be made of steel, aluminum and other suitable materials as would be known to a person skilled in the art. FIG. 7 illustrates a dual arm embodiment where sloped roof engaging member 26 and vertical member 24 each composed of two frame elements. Safety line attachment member 28 can be formed by the mating of the frame elements of sloped roof engaging member 26 to form an eyelet for attaching a safety line. FIG. 8 illustrates a single-arm embodiments where sloped roof engaging member 26 and vertical member 24 are each composed of a single frame element. The dual-arm embodiment shown in FIG. 7 can have a locking adjustment mechanism that allows hinge 32 to be placed anywhere along vertical member 24 to accommodate variable height of fascia 14 of different roof constructions. An adjustable vertical height member 24 can also be considered a compressive adjustment mechanism that allows slip-on eave brace 20 to clasp eave 10.

Soffit load distributing member 22 can be comprised of a load bar 23 that transfers fall arrest loads applied to slip-on eave brace 20 into soffit 18. Preferably, load bar 23 has a sufficient length and surface area to safely distribute fall arrest forces into soffit 18. Dimensions of load bar 23 can vary but typically has a length of at least 32 inches to apply fall arrest forces to at least two rafters 12.

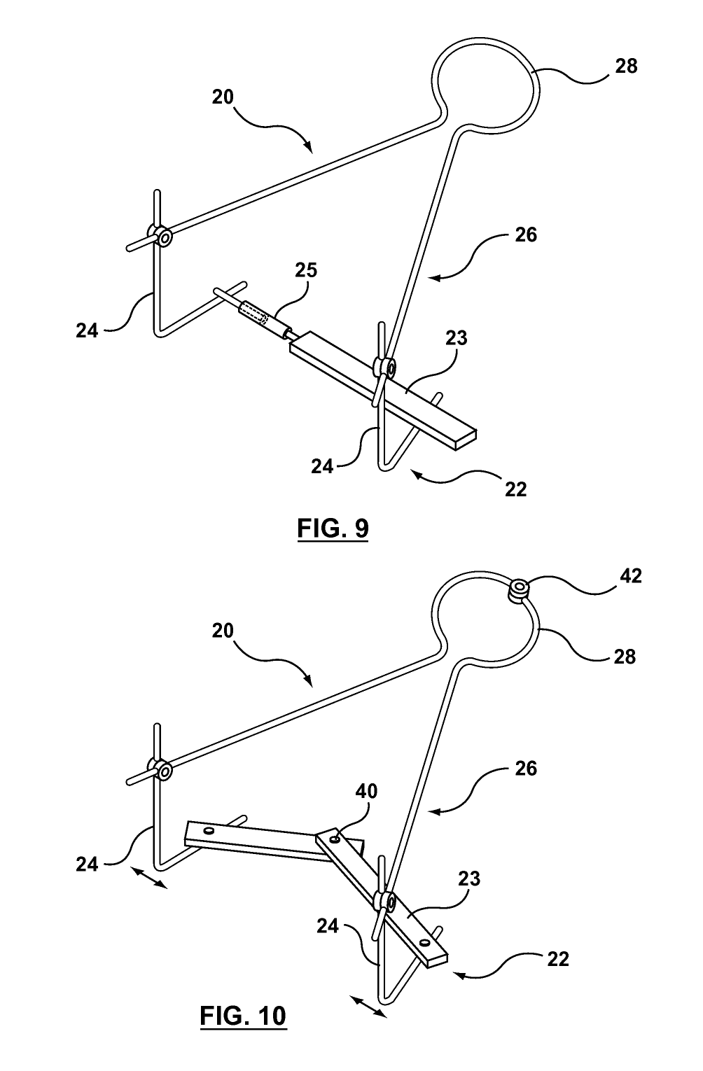

Under fall arrest forces in dual arm embodiments of slip-on eave brace 20, load bar 23 will also be subject to compression forces as frame elements of sloped roof surface engaging member 26 are forced to move inwards towards each other. Load bar 23 can have some flexibility to allow load bar 23 to absorb a portion of the fall arrest forces. Load bar 23 can also be comprised of a shock absorber 25, as shown in FIG. 9, to allow slip-on eave brace 20 to absorb some of the fall arrest forces into the brace itself and away from the roofing materials.

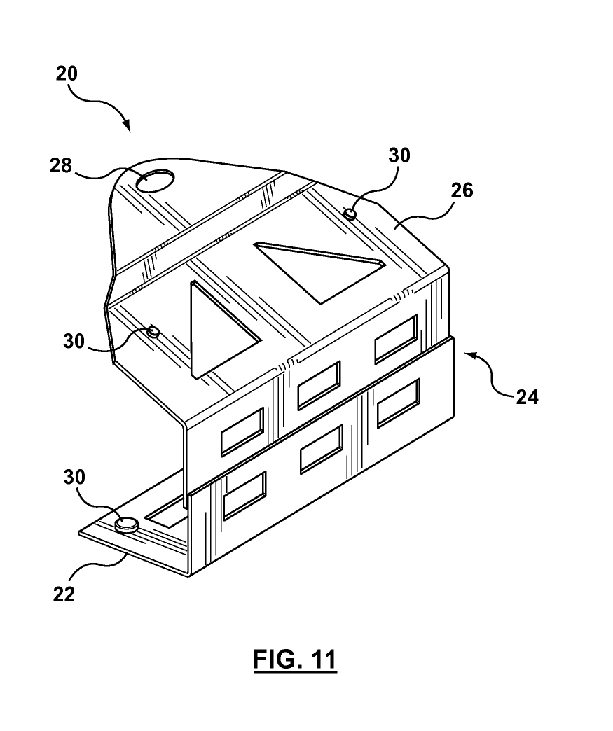

A collapsible dual-arm embodiment of slip-on eave brace 20 is illustrated in FIG. 10. Collapsible slip-on eave brace 20 allows collapsing for easier transport. A mid-portion of load bar 23 can have a hinge 40 to allow the dual arms of sloped roof engaging member to moved towards each other. The dual arm frame elements of sloped roof engaging member 26 can also be hingedly connected to facilitate collapsing of slip-on eave brace 20. Hinged connection 42 can be made in the eyelet of safety line attachment member 28 as illustrated in FIG. 10.

Referring to FIG. 11, an embodiment of slip-on eave brace 20 with an adjustable height vertical member 24 is illustrated. The height of the fascia 16 of the eave 10 can vary with different roof constructions. An adjustable height vertical member 24 allows slip-on eave brace 20 to be adjusted so that vertical member 24 has a similar height. Slip-on eave brace 20 can be a two-piece design as illustrated in FIG. 11 so that the two pieces overlap through a guide and can be locked into position by an adjustment mechanism. Other embodiments can allow for an adjustable height of vertical member 24 using other means, such as, for example, the dual-arm embodiment of FIG. 7 that has a locking adjustment mechanism that allows hinge 32 to placed anywhere along vertical member 24 to accommodate the height of fascia 16.

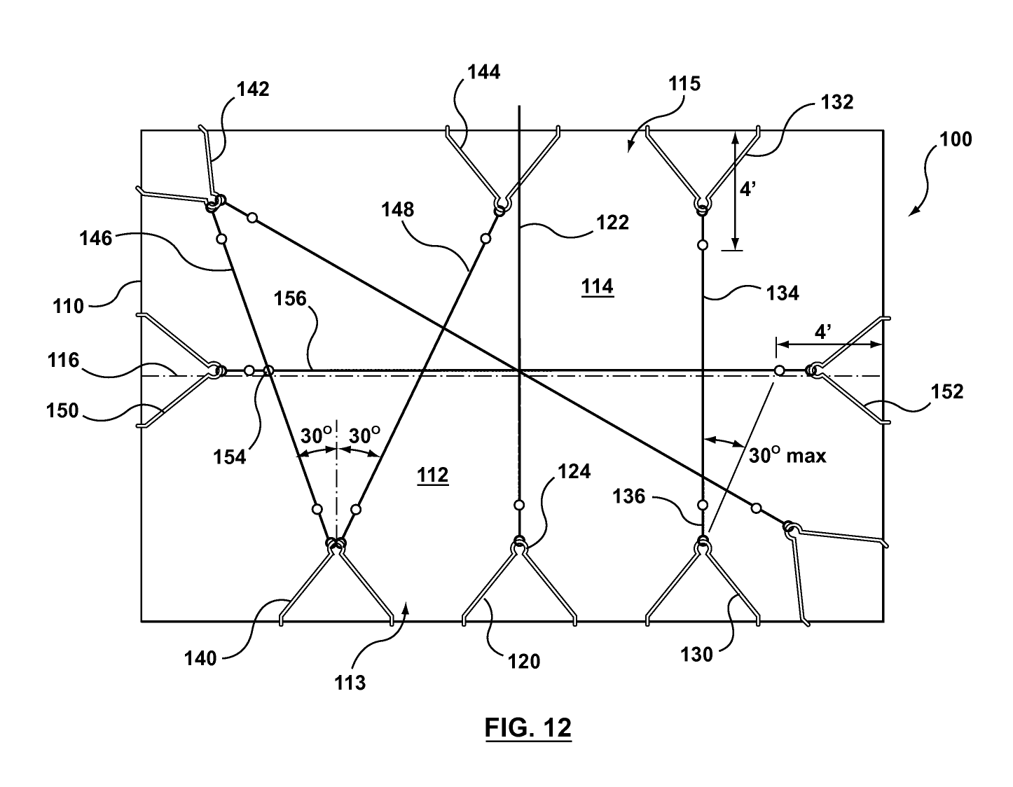

Referring now to FIG. 12, a top plan view of a sloped roof fall arrest system 100 is illustrated installed on a sloped roof 110. Sloped roof 110 has a south side 112 and north side 114 separated by peak 116 of sloped roof 110. Southern eave 113 is opposite northern eave 115. Sloped roof fall arrest system 100 can be comprised of one or more of slip-on eave brace 20 and in any number of combinations, and using any of the above described embodiments or variations thereof.

The simplest embodiment of sloped roof fall arrest system 100 can be comprised of a single slip-on eave brace 120 having a safety line 122 attached thereto via safety line attachment member 124. A single brace system provides fall protection to a worker attached to the safety line on the sloped roof surface opposing the eave to which the brace is attached. In the example shown in FIG. 12, slip-on eave brace device is coupled to the eave of south side 112 of sloped roof 110 to provide fall protection to a worker coupled to safety line 122 working on north side 114 of sloped roof 110. The worker would typically wear a harness that is attached via a lanyard to safety line 122 using a rope grab with a manual or locking cam arrangement. The worker could then have fall protected, free travel of north side 114.

Sloped roof fall arrest system 100 can provide fall protection on both sides of peak 116 using opposing slip-on eave braces that are coupled by a safety line between opposing north and south eaves 113, 115. An example embodiment is provided in FIG. 12 by south eave brace 130 and north eave brace 132 coupled by safety line 134. A worker would then connect the lanyard of their harness to safety line 134 using a caribiner to allow the worker uninterrupted mobility and full travel between south eave brace 130 and north eave brace 132 while being protected from falls. In some embodiments, multiple safety lines can be coupled to slip-on eave braces to allow each safety line connected to a brace to provide fall protection for a worker. For example, an additional safety line can be coupled between south eave brace 130 and north eave brace 132 to allow another worker to connect to the additional safety line. Another example is provided in FIG. 12 where a second south eave brace 140 is coupled to two opposing eave braces 142, 144 via safety lines 146, 148.

Safety line 134 can be kept taut to help secure north and south eave braces 130, 132 to sloped roof 110. Safety line 134 can be simply tied to maintain a desired tension, or other embodiments of sloped roof fall arrest system 100 can incorporate a tensioning device to apply the desired tension to the safety line 134. For example, a ratcheting rope tensioner can be used to apply tension to safety line 134. Other embodiments could further include a tension indicator that could be incorporated with the tensioning device or separately in-line with safety line 134 that can indicate whether safety line 134 has sufficient tension. Preferred tension is enough to ensure that north and south eave braces 130, 132 are engaged with their respective eaves but not enough to damage soffit 18 from tension in safety line 134.

Sloped roof fall arrest system 100 can also provide travel restraint to limit a worker's travel just far enough to reach the edge of sloped roof 110 although not far enough to fall over. Safety line attachment member 28 can comprise a restraint sling 136 that extends from slip-on eave brace 130 to provide an extension for coupling with safety line 134. The safety line coupling element of restraint sling 136 is large enough to prevent a carabiner from traveling from safety line to the restraint sling 136. The combined distance of restraint sling 136 and distance of sloped roof engaging member 26 from the roof edge will allow the worker to match that distance with a lanyard of equivalent length. This can help ensure that the worker is limited from going beyond the roof edge while connected to safety line 134.

Unlike other fall arrest schemes, sloped roof fall arrest system 100 provides fall protection during the setup process. Most jurisdictions allow a worker to access and egress a roof top while unprotected but require that the worker is protected while working, including setting up a fall protection system. In order to install sloped roof fall arrest system 100 a worker would place first slip-on brace 130 onto the eave of sloped roof 110 while on a ladder prior to accessing the roof. The worker would attach the lanyard of the worker's safety harness to safety line 134 (already attached to safety line attachment member 28) using a rope grab. The rope grab should be aligned toward peak 116 and north side 114 of roof 110. Next the worker accesses roof 110 and simply walks upwards over peak 116 of sloped roof 110 and is protected while working on north side 114 of sloped roof 110 opposite slip-on brace 130. Once past peak 116 the worker is fully protected and can begin working on north side 114 or install north eave brace 132. Since north eave brace 132 does not require any tools to install, the worker does not need to carry additional tools when accessing sloped roof 110.

Fall protection is also provided while eave braces are removed from the eave or relocated on the eave. For example, fall protection is provided to allow north eave brace 132 to be moved along northern eave 115 or removed so long as the worker is connected to safety line 134 coupled to south eave brace 130.

To leave roof 110, the worker can descend from peak 116 towards southern eave 113, access the ladder and then remove south eave brace 130 once on the ladder. The worker would not be fall protected when descending from peak 116, however, fall protection is not typically required in this situation as the worker is in transit and leaving the roof.

Alternative slip-on brace designs are also illustrated in FIG. 12 to allow an eave brace to be fixed to an eave corner or at the peak of roof 110. Slip-on eave brace can be adapted for coupling to the corner of an eave. For example, slip-on eave brace 142 can further include an end cap that provides a second vertical member that is at a right angle to vertical member 24 to allow both vertical members to engage the eave corner. Soffit load distributing member 22 can also be adapted to the profile of the corner of the eave (i.e. have a right angle). Peak slip-on eave braces 150, 152 can further be adapted to meet the profile and slope of peak 116.

Another feature illustrated in FIG. 12 is a connecting link 154 that couples safetylines 146, 156 together to provide increased strength to the system along with increased mobility for the worker. A grid can be arranged with safety lines crossing peak 116 and safety lines parallel to peak 116 that are coupled at crossing points by connecting links 154. Fall arrest forces can be redirected through connecting link 154 into other braces that are coupled to that link via a safety line. The worker can have a safety harness with two lanyards attached to allow the worker to attach the second lanyard to the other side of the safety line when crossing connecting link 154 in order to avoid the worker being unprotected when crossing connecting link 154.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A slip-on eave brace for providing fall protection on a sloped roof, the brace comprising:
a soffit load distributing member;
a vertical member coupled to the soffit load distributing member; and
a sloped roof engaging member coupled to the vertical member at an end portion of the sloped roof engaging member; and
a safety line attachment member fixed to an opposing end portion of the sloped roof engaging member.

17. The slip-on eave brace of claim 16, wherein the sloped roof engaging member is hingedly coupled to the vertical member to allow an angle between vertical member and sloped roof engaging member to be adjusted, and the slip-on eave brace further comprising a position lock to fix the angle between vertical member and sloped roof engaging member.

18. The slip-on eave brace of claim 17, wherein the position lock is a locking swivel.

19. The slip-on eave brace of claim 17, wherein the position lock further comprises a compressive adjustment mechanism to apply a compressive force between sloped roof engaging member and soffit load distributing member.

20. The slip-on eave brace of claim 18, wherein the compressive adjustment mechanism comprises at least one straight line clamp having a plunger that engages an outwardly curved portion of the vertical member.

21. The slip-on eave brace of claim 16 further comprising at least one friction member on a lower surface of the sloped roof engaging member.

22. The slip-on eave brace of claim 16 further comprising a compressive adjustment mechanism.

23. The slip-on eave brace of claim 22, wherein the compressive adjustment mechanism is a screw plunger that engages a threaded bore in the sloped roof engaging member.

24. The slip-on eave brace of claim 16, wherein the soffit load distributing member has a shock absorber.

25. The slip-on eave brace of claim 16, wherein the safety line attachment member comprises a travel restraint sling for attaching the safety line thereto.

26. The slip-on eave brace of claim 16, wherein the vertical member has an adjustable height.

27. A sloped roof fall arrest system to provide fall protection to a user on a sloped roof having eaves using the slip-on eave brace device of claim 26, the system comprising:
the slip-on eave brace device coupled to one of the eaves;
a safety line coupled to the safety line attachment member, and the safety line provided to a sloped roof surface opposing the eave; and
a rope grab to fixedly couple the user to the safety line to provide fall protection on the sloped roof surface opposing the eave.

28. A sloped roof fall arrest system to provide fall protection to a user on a sloped roof using the slip-on eave brace device of claim 27, the system comprising:
at least two slip-on eave brace devices for coupling to opposing eaves of the sloped roof;
a safety line connected between the safety line attachment members of the at least two slip-on eave brace devices; and
a coupling mechanism to couple the user to the safety line to allow the user to have fall-protected travel on the sloped roof between the at least two slip-on eave brace devices.

29. The sloped roof fall arrest system of claim 28, wherein the safety line is tautly connected to secure the at least two slip-on eave brace devices to the opposing eaves.

30. The sloped roof fall arrest system of claim 29 further comprising a tensioning device to apply tension to the safety line.
